(19) United States
(12) Patent Application Publication
(10) Pub. No.: US 2008/0179777 A1
(43) Pub. Date: Jul. 31, 2008

(54) POLYOLEFIN-CONTAINING MATERIAL WITH INTERNAL ADDITIVE AND METHOD FOR SOFTENING FINISHING OF AN ARTICLE INCLUDING A POLYOLEFIN

(76) Inventors: Christine Wild, Hilden (DE); Rolf Stein, Langenfeld (DE); Hans-Georg Kraemer, Dormagen (DE)

Correspondence Address: COGNIS CORPORATION;PATENT DEPARTMENT, 300 BROOKSIDE AVENUE, AMBLER, PA, 19002, US

(21) Appl. No.: 12/058,929

(22) Filed: Mar. 31, 2008

Related U.S. Application Data
(63) Continuation of application No. 11/704,605, filed on Feb. 9, 2007, now abandoned.

(30) Foreign Application Priority Data
Feb. 11, 2006 (DE) 10 2006 006 396.1

(51) Int. Cl. B29C 47/08; C08K 5/06

(52) U.S. Cl. 264/128; 524/378

(57) ABSTRACT

A polyolefin-containing material including an internal additive, where the internal additive is a triglyceride according to the structure (T):

CH₂(OR¹)—CH(OR²)—CH₂(OR³) (T)

where R¹, R² and R³ are, independently of one another, saturated, mono- or poly-olefinically unsaturated acyl groups containing 8 to 24 carbon atoms, the chain lengths of the acyl groups are the same or different, and the polyolefin-containing material exhibits improved softness is provided. A process for the softening finishing of articles including polyolefins is also provided and includes adding a triglyceride to polymer granules including a polyolefin present in an amount of from about 0.1% to about 40% by weight, based on the weight of the granules, and subjecting to further processing to form a fiber or film.

### CROSS-REFERENCE TO RELATED APPLICATIONS

This application claims priority under 35 U.S.C. § 119 from German Patent Application No. 102006006396.1, filed Feb. 11, 2006, the entire disclosure of which is hereby incorporated herein by reference.

### BACKGROUND OF THE INVENTION

1. Field of the Invention

This invention relates generally to polyolefin-containing materials and methods for softening finishing of an article containing a polyolefin, and more particularly to polyolefin-containing materials with an internal triglyceride additive, and methods for softening finishing of articles containing a polyolefin with a triglyceride.

2. Background Information

WO 031068856 describes the use of compounds with the general formulae A-B-C-B-A (I) and A-B-A (II) for the softening finishing of polyolefin-containing articles. In these formulae, A represents a group R—COO, where R is a saturated, branched or unbranched alkyl group containing 7 to 21 carbon atoms, B represents a group (CₙH₂ₙO)ₖ, where n is an integer of 2 to 4 and k may assume a value of 1 to 15, and C in formula (I) represents a linear or branched alkylene group containing at least 2 and at most 6 carbon atoms. The index k relates to the individual group B and does not indicate the total number of groups B in the molecule. The index k varies in view of the various, technically produced degrees of alkoxylation of the individual molecules and, accordingly, may even be an odd number.

So far as the present invention is concerned, it is specifically pointed out that the additives (I) and (II) to be used in accordance with WO 03/068856 provide the polyolefins with hydrophilic and not hydrophobic properties and, for the rest, differ structurally from the triglycerides to be used in accordance with the present invention to a considerable extent.

It is known that mono- and diglycerides are used as additives for polyolefins, more particularly as antistatic agents and as lubricants. However, these are uses which have nothing to do with the use as softeners in accordance with the present invention. So-called white oils, i.e. paraffins, are normally used as softeners for polyolefins. For example, according to U.S. Pat. No. 6,201,053, partly saponified triglycerides can be used as lubricants, antistatic agents, stabilizers, coupling agents or waterproofing agents. However, there is no mention of the use of triglycerides as softeners for polyolefins.

JP 62010141A2 (cited in Chem. Abstracts 1987: 215172 CAPLUS) describes water-permeable plastic films having good mechanical strength and high permeability to water, these materials being obtained by melting and shaping of 100 parts polyolefin, 20-500 parts fillers and 100 parts triglycerides. For example, 100 parts Ultzex 3021 F (a linear low-density polyethylene), 150 parts calcium carbonate, 5 parts stearic acid and 30 parts hydrogenated coconut oil are used. There is no mention of the suitability of triglycerides as softeners for polyolefins.

U.S. Pat. No. 4,578,414 describes fibers and filaments, more particularly polyolefin-based fibers and filaments, which contain wetting agents. Suitable wetting agents include, inter alia, mono-, di- or triglycerides. However, there is no mention of the use of triglycerides as softeners for polyolefins.

### SUMMARY OF THE INVENTION

Briefly described, according to an aspect of the invention, a polyolefin-containing material includes an internal additive, where the internal additive is a triglyceride according to the structure (T):

CH₂(OR¹)—CH(OR²)—CH₂(OR³) (T)

where R¹, R² and R³ are, independently of one another, saturated, mono- or poly-olefinically unsaturated acyl groups containing 8 to 24 carbon atoms, the chain lengths of the acyl groups are the same or different, and the polyolefin-containing material exhibits improved softness.

According to another aspect of the invention, a process for the softening finishing of articles including polyolefins includes the steps of adding triglycerides to polymer granules containing a polyolefin present in an amount of from about 0.1% to about 40% by weight, based on the weight of the granules; and subjecting to further processing to form a fiber or film.

### DETAILED DESCRIPTION OF THE INVENTION

The problem addressed by the present invention was to provide additives which would be suitable as softeners for polyolefins, more particularly for polyolefins used in the form of fibers, filaments and sheet-form textiles for hygiene articles, medical articles, household textiles, clothing and the like.

Another problem addressed by the invention was to ensure that, although providing the polyolefins with softness, the additives would not adversely affect other properties of the polyolefins. In particular, there would be no significant reduction in the processability, thermal stability or tendency to yellowing of the polyolefins, neither would the textile properties of the polyolefins be adversely affected.

A narrower problem concerned polyolefin nonwovens used in the hygiene field. Polyolefins have been used for decades for the production of nonwovens in the hygiene field. Until a few years ago, carded nonwovens, i.e., nonwovens produced from stable fibers, were used. In recent years, so-called spunbonded nonwovens have been increasingly used. Spunbonded nonwovens have significantly poorer softness by comparison with carded nonwovens. Because of this poorer softness, greater friction occurs on contact with the skin, resulting in irritation of the skin or even diaper dermatitis. Against this background, the particular problem addressed by the present invention was to provide plasticizers for polyolefin-based spunbonded nonwovens, the polyolefins being intended to retain their hydrophobic character, particularly for the so-called leg cuffs, in order to prevent the diapers from leaking. According to the present invention, a polyolefin fiber is regarded as hydrophobic when sink times of at least 24 hours are achieved in the sink test defined hereinafter.

It has now surprisingly been found that triglycerides excellently satisfy the stated problem in every respect.

The present invention relates to the use of triglycerides as softeners for polyolefins. It is expressly pointed out that, according to the present invention, the triglycerides are used as internal additives for polyolefins.

### Triglycerides

Triglycerides are generally understood among experts to be compounds having the structure (T):

CH₂(OR¹)—CH(OR²)—CH₂(OR³) (T)

in which the substituents R¹, R² and R³ represent acyl groups containing 8 to 24 carbon atoms. Accordingly, triglycerides are triesters of glycerol of which the three hydroxyl groups are esterified by fatty acids. The chain lengths of the substituents R¹, R² and R³ may be the same or different. The substituents R¹, R² and R³—again independently of one another—may be saturated or mono- or polyolefinically unsaturated.

According to the present invention, the triglycerides are used in polyolefin-containing materials, preferably fibers, sheet-form materials, such as nonwovens and films, for improving softness. Accordingly, they perform the function of softeners. Accordingly, the use of the triglycerides (T) in accordance with the invention as internal additives leads to polyolefin-containing products with high softness.

To soften the polyolefins, more particularly polypropylene, the triglycerides are used in quantities of 0.1 to 100 phr, preferably in quantities of 0.1 to 40 phr and more particularly in quantities of 0.1 to 10 phr. A quantity of 1 to 5 phr is most particularly preferred. The abbreviation “phr” (parts per hundred resin) familiar to the expert indicates how many parts by weight of a component (here: triglyceride) are present in the plastic (here: polyolefin), based on 100 parts by weight plastic.

Basically, the manner in which the triglycerides are added to the polyolefin is not limited and any methods known to the relevant expert may be used. For example, the triglycerides may be added to the polyolefin in pellet or granule form. However, the triglycerides may also be used in the form of a so-called master batch.

Basically, there are no limits as to the nature of the triglycerides. The triglycerides may be of natural or synthetic origin. Individual species or mixtures may be used. In one embodiment, triglycerides of technical quality are used, their triglyceride content amounting to at least 60% by weight, preferably to at least 80% by weight and more particularly to at least 90% by weight.

Preferred chain lengths of the acyl groups R¹, R² and R³ of the triglycerides are C₁₂ to C₂₄ and more particularly C₁₆ to C₂₄.

### Polyolefins

As already mentioned, the polyolefins are those which are used in particular in the form of fibers, filaments and sheet-form textiles for hygiene articles, medical articles, household textiles, clothing and the like. These are, inter alia, materials used for personal products, such as diapers, incontinence products, panty liners, and medical products for healing wounds, household textiles, such as carpets or bed inserts, sports clothing, underwear. These materials may be nonwovens or knitted, woven or tufted textiles. The textiles may be produced in single-stage or multi-stage processes.

So far as the polyolefin-containing material is concerned, any known types of polymer and copolymer based on ethylene or propylene are basically suitable. In principle, mixtures of pure polyolefins with copolymers are suitable. In addition, the additives may be used in blends of polyolefins with other synthetic polymers, for example polyesters, or natural polymers, for example cotton, viscose, cellulose or hemp, in order to provide the polyolefin fibers with greater softness.

Polymers particularly suitable for the purposes of the teaching according to the invention are listed below: poly(ethylenes), such as HDPE (high-density polyethylene), LDPE (low-density polyethylene), VLDPE (very-low-density polyethylene), LLDPE (linear low-density polyethylene), MDPE (medium-density polyethylene), UHMPE (ultra high molecular polyethylene), VPE (crosslinked polyethylene), HPPE (high-pressure polyethylene); poly(propylenes), such as isotactic polypropylene; syndiotactic polypropylene; Metallocen-catalyzed polypropylene PP, high-impact polypropylene, random copolymers based on ethylene and propylene, block copolymers based on ethylene and propylene; EPM (poly[ethylene-co-propylene]); EPDM (poly[ethylene-co-propylene-co-unconjugated diene]).

Other suitable polymers are: poly(styrene); poly(methylstyrene); poly(oxymethylene); Metallocen-catalyzed α-olefin or cycloolefin copolymers, such as norbornene/ethylene copolymers; copolymers containing at least 60% ethylene and/or styrene and less than 40% monomers, such as vinyl acetate, acrylates, methacrylates, acrylic acid, acrylonitrile, vinyl chloride. Examples of such polymers are: poly(ethylene-co-ethyl acrylate), poly(ethylene-co-vinyl acetate), poly(ethylene-co-vinyl chloride), poly(styrene-co-acrylonitrile). Also suitable are graft copolymers and polymer blends, i.e., mixtures of polymers in which the above-mentioned polymers inter alia are present, for example polymer blends based on polyethylene and polypropylene. The additives according to the invention are also suitable for the softening of so-called “bico” fibres (core-sheath fibres) produced from PES/PE or PP/PE.

Homopolymers and copolymers based on ethylene and propylene are particularly preferred for the purposes of the present invention. In one embodiment of the present invention, therefore, polyethylene on its own is used as the polyolefin; in another embodiment, polypropylene on its own is used as the polyolefin and, in a further embodiment, ethylene/propylene copolymers are used as the polyolefin.

In a most particularly preferred embodiment of the invention, the triglyceride additives are used in polypropylene fibers.

### Process

The present invention also relates to a process for the softening finishing of articles completely or partly containing polyolefins, in which triglycerides are added to polymer granules completely or partly containing polyolefins in quantities of 0.1 to 100% by weight, based on the granules, followed by processing in known manner to fibers or films, preferably by extrusion. In a preferred embodiment, the triglycerides are used in quantities of 0.1 to 10% by weight, preferably in quantities of 0.1 to 40% by weight and more particularly in quantities of 1 to 5% by weight, based on the granules.

So far as the triglycerides are concerned, the foregoing comments otherwise apply. In particular, there are basically no limits as to the nature of the triglycerides which may be of natural or synthetic origin. In one embodiment, triglycerides of technical quality with a triglyceride content of at least 60% by weight are used. In another embodiment, the triglyceride content of the technical triglycerides is at least 80% by weight and, more particularly, at least 90% by weight.

If desired, one or more other additives, more particularly those typically used in the field of nonwovens, for example antibacterial additives, may be added to the polyolefins besides the triglyceride softeners to be used in accordance with the invention. One embodiment is characterized in that, aside from the triglyceride softeners to be used in accordance with the invention, for example even the technical-quality triglycerides mentioned, mono- and/or diglycerides are not additionally added to the polyolefins as further additives.

If desired, a so-called finish may be additionally applied to the surface of the polyolefin material, for example in the form of a so-called neat finish or in the form of an aqueous solution or emulsion, in order to improve the processing properties of the material.

### EXAMPLES

### Substances Used

### Cegesoft HF 52

Commercially available triglyceride (Cognis Deutschland GmbH & Co. KG)

### Polyolefin

Polypropylene (type PP HF 435 J, a product of Borealis); hereinafter also referred to in short as PP

### Test Methods

### Feel:

To evaluate feel, the filaments to be tested were reeled off by a standard yarn reeling machine and the strands formed were haptically evaluated for softness by three different examiners. The evaluation scale is based on the following scores: score 1=very, very soft, score 2=very soft, score 3=soft, score 4=hard, score 5=very hard, score 6=extremely hard.

### Sink Test:

In the sink test, fibrous material to be tested was tested for its hydrophobic properties in a special apparatus. To this end, a particular quantity of fibers was placed in a wire basket. The wire basket was then placed on the surface of a water bath. In the case of a hydrophilic fiber, it quickly becomes saturated and the wire basket filled with the fibrous material sinks. In the present case, the sink times were measured by photocells attached to the water bath. The fibrous material was obtained by removal from the spool with an air gun.

### Determination of the Mechanical Properties:

In order to quantify the effect of the additive on their mechanical properties, the filaments produced in a spinning test were tear-tested to DIN 53834. The tear test was carried out in a commercially available Statimat (manufacturer: Stein-Textechno). For evaluation, the so-called mechanical constant was introduced, being defined as the product of the measured tear strength with the square root of the breaking elongation of the filament. The higher this value (the closer to the additive-free filament), the better.

### Yellowing:

To evaluate yellowing, the strands to be tested were exposed for 24 hours to temperatures of 110° C. in a drying cabinet. The degree of yellowing was then visually evaluated in comparison with an additive-free strand.

### Embodiment Examples

Polyproylene filaments were spun as partly stretched yam (POY) in a pilot spinning machine consisting of a Barmag type 3E extruder, a melt transfer pipe, a spinning head with rectangular packages and crossflow quenching in the spinning section and of a Barmag type SSW 46 high-speed spooler in the spooling section. The spinning machine was operated with a melt throughput of 30 g/min. divided between 2 filaments each with 36 individual fibers. Heating zones 1/2/3 of the extruder were adjusted to a temperature of 240° C. while the heating of the melt pipe and the spinning head was adjusted to 260° C. The filaments were cooled with cross-flowing quenching air. After cooling, the filaments were not provided in the usual way with a spin finish, instead pure demineralized water was applied in order not to influence the effect of the additive. The filaments were wound at a speed of the drive roller of 2100 m/min, the grooved roller being operated with a lead of 9.5%.

The test additive was first melted, mixed with the polypropylene granules in various quantity ratios and then delivered to the extruder via the feed bush. Cegesoft HF 52 in various quantities was used as the additive (“Additive I” in the following Table).

Particulars of the quantities and the test results can be found in the following Tables.

The filaments obtained were tested as described above in “Test Methods”.

The following results were obtained:

TABLE 1
Feel (determination of softness by the test described above).

| | Examiner | | | |
|---|---|---|---|---|
| | 1 | Examiner 2 | Examiner 3 | Examiner 4 |
| No additive | 4 | 4 | 2 | 3.3 |
| Additive 1 (2%) | 2 | 3 | 1 | 2 |
| Additive 1 (3%) | 1 | 1 | 1 | 1 |

TABLE 2
Sink test (determination of hydrophobic properties by the test
described above).

| | Sink time |
|---|---|
| No additive | >24 h |
| Additive 1 (2%) | >24 h |
| Additive 1 (3%) | >24 h |

TABLE 3
Effect on mechanical properties as determined by the test described above.

| | Breaking | Strength | Strength × √ |
|---|---|---|---|
| | elongation (%) | (cN/dtex) | breaking elongation |
| No additive | 240 | 2.70 | 41.8 |
| Additive 1 (3%) | 275 | 2.20 | 36.5 |

### Yellowing

In order to determine the yellowing potential, additive 1 was sprayed onto PP stable fibers (with an add-on of 0.5%) and a yellowing test was then carried out as described above. In the visual evaluation, additive 1 was evaluated as white (=non-yellowing).

What is claimed is:

1. A polyolefin-containing material comprising an internal additive, wherein the internal additive is a triglyceride according to the structure (T):
CH₂(OR¹)—CH(OR²)—CH₂(OR³) (T)
wherein R¹, R² and R³ are, independently of one another, saturated, mono- or poly-olefinically unsaturated acyl groups containing 8 to 24 carbon atoms, wherein the chain lengths of the acyl groups are the same or different, and wherein the polyolefin-containing material exhibits improved softness.

2. The polyolefin-containing material according to claim 1, wherein the acyl groups contain 12 to 24 carbon atoms.

3. The polyolefin-containing material according to claim 1, wherein the acyl groups contain 16 to 24 carbon atoms.

4. The polyolefin-containing material according to claim 1, wherein the triglyceride is present in an amount of from about 0.1 to about 100 phr.

5. The polyolefin-containing material according to claim 1, wherein the triglyceride is present in an amount of from about 0.1 to about 40 phr.

6. The polyolefin-containing material according to claim 1, wherein the triglyceride is present in an amount of from about 1 to about 5 phr.

7. The polyolefin-containing material according to claim 1, wherein the triglycerides are of natural origin.

8. The polyolefin-containing material according to claim 1, wherein the triglycerides are of technical quality with a triglyceride content of at least 60% by weight.

9. The polyolefin-containing material according to claim 1, wherein the polyolefin-containing material is in the form of a spunbonded nonwoven material.

10. The polyolefin-containing material according to claim 1, wherein the polyolefin is selected from the group consisting of a polyethylene, a polypropylene, and an ethylene/propylene copolymer.

11. The polyolefin-containing material according to claim 10, wherein the polyolefin is polypropylene.

12. The polyolefin-containing material according to claim 1, incorporated into a hygienic product.

13. The polyolefin-containing material according to claim 1, incorporated into a textile.

14. A process for the softening finishing of articles comprising polyolefins, comprising the steps of:
adding a triglyceride to polymer granules comprising a polyolefin present in an amount of from about 0.1% to about 40% by weight, based on the weight of the granules; and
subjecting to further processing to form a fiber or film.

15. The process according to claim 14, wherein the step of subjecting to further processing includes extrusion.

16. The process according to claim 14, wherein the triglycerides are added in an amount of from about 1% to about 5% by weight, based on the weight of the granules.

17. The process according to claim 14, wherein a fiber is formed.

18. The process according to claim 14, wherein a film is formed.

19. The process according to claim 14, wherein the triglycerides are of natural origin.

20. The process according to claim 14, wherein the triglycerides are of technical quality with a triglyceride content of at least 60% by weight.

21. The process according to claim 14, wherein the polyolefin is selected from the group consisting of a polyethylene, a polypropylene, and an ethylene/propylene copolymer.

22. The process according to claim 21, wherein the polyolefin is polypropylene.
